(19) United States
(12) Patent Application Publication
(10) Pub. No.: US 2023/0230013 A1
(43) Pub. Date: Jul. 20, 2023

(54) EVENT DETECTION AND TRAINING RESPONSE

(71) Applicant: SITE VANTAGE, INC., Westport, CT (US)

(72) Inventors: Shawn Bonnington, Trinity, FL (US); Adnan Aziz, Frisco, TX (US)

(21) Appl. No.: 17/580,518

(22) Filed: Jan. 20, 2022

(51) Int. Cl. G06Q 10/06

(52) U.S. Cl. CPC G06Q 10/06395; G06Q 10/06398; G06Q 10/063114

(57) ABSTRACT

Systems and methods to provide training content to equipment operators and determine the success of the training content. Sensor data is captured during a user’s operation of the equipment. The sensor data is analyzed to detect an event in the operation of the equipment. In response to detecting an event, training content for the event is selected and presented to the user. If the user does not consume the training content, the content is re-presented to the user. If the user consumed the training content, but a reoccurrence of the event is detected in additional sensor data, then the training content is labeled as being unsuccessful at training the user to avoid the event. In response to the training content being unsuccessful at training the user, additional training content may be provided to the user or a modification to the equipment may be suggested.

### TECHNICAL FIELD

The present disclosure relates generally to digital content presentation and, more particularly, to monitoring user equipment to detect events and provide recommended training content.

### BACKGROUND

### Description of the Related Art

Many computing devices of today monitor and track various aspects of the device. For example, many smart watches capture inertial sensor data to determine if the wearer is walking or sitting still. Similarly, many automobiles track the vehicle’s location and where the vehicle stops. Moreover, some types of heavy equipment track various aspects of the equipment’s use, such as engine metrics. These data, however, can be difficult for a user to interpret and utilize. It is with respect to these and other considerations that the embodiments described herein have been made.

### BRIEF SUMMARY

Briefly described, embodiments are directed toward systems and methods of providing training content to equipment operators and determining the success of the training content. Sensor data associated with a user’s operation of equipment is received and analyzed for events. In response to detecting an event, an event type for the event is identified and used to select training content to teach the user to avoid the event. The selected training content is presented to the user. If the user consumed the content, an indication that the user consumed the selected training content is received. As additional sensor data is being received and analyzed for events, the success of the selected training content is determined if a reoccurrence of the event is detected. If the selected training content is unsuccessful at training the user to avoid the event, then other training content may be selected and presented to the user.

In some embodiments, a history of events by the same user or by different users may be used to determine the success of the training content. Moreover, a history of events on a same piece of equipment or on multiple pieces of content of a same equipment type may be utilized to determine if the training content is successful or insufficient at training the user to avoid the event. The success of the training content and the history of events can also be used to determine if there is an issue with the equipment, rather than operator error. If there is an issue with the equipment, the system can recommend modifications to the equipment.

Embodiments described herein can improve the operation of the equipment, extend the longevity of the equipment or its parts, improve user performance, and even improve the operation of the various computing components of the system. For example, by providing successful training content to users, fewer events may be detected by the system, which can reduce computer resource utilization and data transfers in selecting and providing training content to users.

### BRIEF DESCRIPTION OF THE SEVERAL VIEWS OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings:

FIG. 1 illustrates a context diagram of an environment for tracking and utilizing user-equipment data to provide training content to a user in accordance with embodiments described herein;

FIG. 2 is a context diagram of non-limiting embodiments of systems for tracking and utilizing user-equipment data to provide training content to a user in accordance with embodiments described herein;

FIGS. 3A-3B illustrate a logical flow diagram showing one embodiment of a process for tracking and utilizing user-equipment data to provide training content to a user in accordance with embodiments described herein; and

FIG. 4 shows a system diagram that describe various implementations of computing systems for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

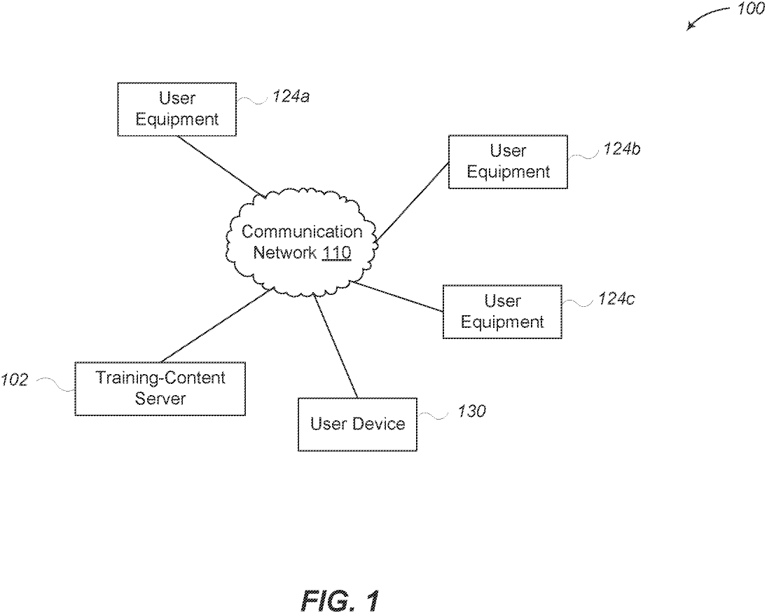

FIG. 1 illustrates a context diagram of an environment 100 for tracking and utilizing user-equipment data to provide training content to a user in accordance with embodiments described herein. Environment 100 includes a training-content server 102, equipment 124a-124c (also referred to as equipment 124), and a user device 130. In some embodiments, the user device 130 may be optional and may not be included. Although FIG. 1 illustrates three pieces of user equipment 124a-124c, embodiments are not so limited. Rather, one or more user equipment 124 may be included in environment 100.

The user equipment 124a-124c may be any type of equipment or machinery that is operable by a user such that the equipment’s operation or performance is influenced by user input or involvement. As discussed in more detail below, each user equipment 124a-124c includes one or more sensors. These sensors collect data regarding some aspect of the user equipment 124a-124c as the user equipment 124a-124c is being operated by the user.

In some embodiments, the user equipment 124a-124c includes mobile equipment, such as bulldozers, backhoes, semi-trucks, snowplows, dump trucks, or other mobile equipment operated by a user. In other embodiments, the user equipment 124a-124c may include non-mobile equipment, such as rock crushing systems, conveyer-belt systems, factory-plant systems or equipment, or other types of non-mobile equipment operated by a user. In various embodiments, the user equipment 124a-124c may include a combination of mobile equipment and non-mobile equipment. The above examples of user equipment 124a-124c are for illustrative purposes and are to be not limiting.

Each user equipment 124a-124c may be referred to as an individual and specific piece of equipment or may be of a particular equipment type, or both. For example, equipment 124a may have an equipment type of bulldozer and an individual equipment identifier as BullDozer_123. In comparison, equipment 124b may have an equipment type of rock crushing system, but not individually identifiable from other systems of the same type. As discussed herein, the training content provided to a user of the equipment may be tailored for the specific piece of equipment or for the particular equipment type.

The training-content server 102 collects the sensor data from each user equipment 124a-124c via communication network 110. Communication network 110 includes one or more wired or wireless networks in which data or communication messages are transmitted between various computing devices.

The training-content server 102 analyzes the sensor data to detect events that occurred while users are operating the user equipment 124a-124c. In some embodiments, this detection may be in real time as sensor data is being captured during the users’ operation of the user equipment 124a-124c. In other embodiments, the event detection may be post-operation or delayed depending on access to the communication network 110. For example, if the user equipment 124a-124c is not within wireless range of the communication network 110, then the sensor data may be collected after the user is done operating the equipment, such as the sensor data being downloaded to the training-content server 102 at the end of the day via a wired connection.

Examples of detected events may include, but are not limited to, improper gear shifting, unsafe driving speeds, improper use of equipment or equipment accessories (e.g., positioning the accessory in an incorrect position or arrangement, picking up too heavy of a load, etc.), visual or audio warnings being presented by the equipment, user body movements while the equipment is being operated (e.g., a user pushing a button or manipulating a switch, a user ignoring a visual or audio warning in the equipment, etc.), or other types of events. As discussed herein, the events may be detected by the value or values of sensor data from a single sensor or from a combination of sensors. Moreover, the events may be based on a single sensor data values or trends in the sensor data over time.

Although the training-content server 102 is illustrated as being separate from the user equipment 124a-124c and the user device 130, embodiments are not so limited. In some embodiments, the training-content server 102 or the functionality of the training-content server 102 is embedded in the individual user equipment 124a-124c. In this way, the user equipment can more quickly analyze its sensor data and select training content to present to the user. Moreover, the user equipment 124a-124c can store training content that is specific to that equipment or that equipment type. In other embodiments, user device 130 is in communication with the user equipment 124a-124c and the training-content server 102 or the functionality of the training-content server 102 is embedded in the user device 130.

After the training-content server 102 detects an event, the training-content server 102 selects training content to provide to the user that was operating the user equipment 124 when the sensor data was collected that resulted in the event. In some embodiments, the training-content server 102 provides the training content to the user equipment 124 via the communication network 110 for presentation to the user through a user interface of the user equipment 124. For example, the user equipment 124 may include a head unit, display device, audio system, or other audiovisual system to present the training content to the user. In at least one embodiment, the operation of the user equipment 124 by the user may be paused or locked until the user consumes (e.g., watches, reads, or listens to) the training content.

In other embodiments, the training-content server 102 may provide the training content to the user device 130 via communication network 110 for presentation to the user. The user device 130 is a computing device that can receive training content and present it to a user. Examples of a user device 130 may include, but are not limited to, mobile devices, smartphones, tablets, laptop computers, desktop computers, or other computing devices that can communication with the training-content server 102 and present training content to a user. In various embodiments, the user device 130 may be separate or remote from the user equipment 124a-124c and may not be included in the operation of the user equipment. In other embodiments, a user device 130 may be integrated or embedded in each separate user equipment 124a-124c.

In some other embodiments, the training-content server 102 may provide the training content to the user via a display device of the training-content server 102.

In various embodiments, sensor data from a plurality of users or a plurality user equipment 124a-124c may be aggregated to detect events or select training content. For example, if an event is detected for each of a plurality of different users that are operating as same piece of user equipment 124a, then the training content may be selected and provided to each of those plurality of users to educate the plurality of users on how to properly operate that piece of equipment. As another example, if an event is detected for each of a plurality of different pieces of user equipment 124 of a same equipment type, then the training content may be selected for that equipment type and provided to users that operate that type of equipment. As yet another example, if a similar event is detected for each of a plurality of different types of user equipment 124 that have a same feature, then the training content may be selected for that feature and detected event and provided to users that operate any type of equipment having that feature.

In various embodiments, the training-content server 102 may also track the success of the selected training content over time or issues with the equipment 124. In some embodiments, an indication of whether the user consumed the training content may be obtained. If the user consumed the training content and an event associated with the training content re-occurs then the training content may have been unsuccessful at training the user to avoid the event. But if the user did not consume the training content, then the training content may be re-provided to the user in response to another detection of the same or similar event.

In other embodiments, a history of events for particular equipment or for a plurality of equipment may be analyzed for issues with the equipment, rather than the users operating the equipment. For example, if a same or similar event is detected for a plurality of different equipment of a same type, then the training-content server 102 can determine that there is an issue with that equipment type. In response, the training-content server 102 can generate an equipment modification recommendation based on the event type. For example, assume multiple users have difficulty engaging a particular button on the equipment, which is repeatedly detected as an event because of improper operation due to failure to engage the button, then the training-content server 102 can generate a suggestion to modify the button. This suggestion may be presented to the user, an administrator, or an equipment maintenance individual via the user device 130 or an audiovisual interface (not illustrated) of the training-content server 102.

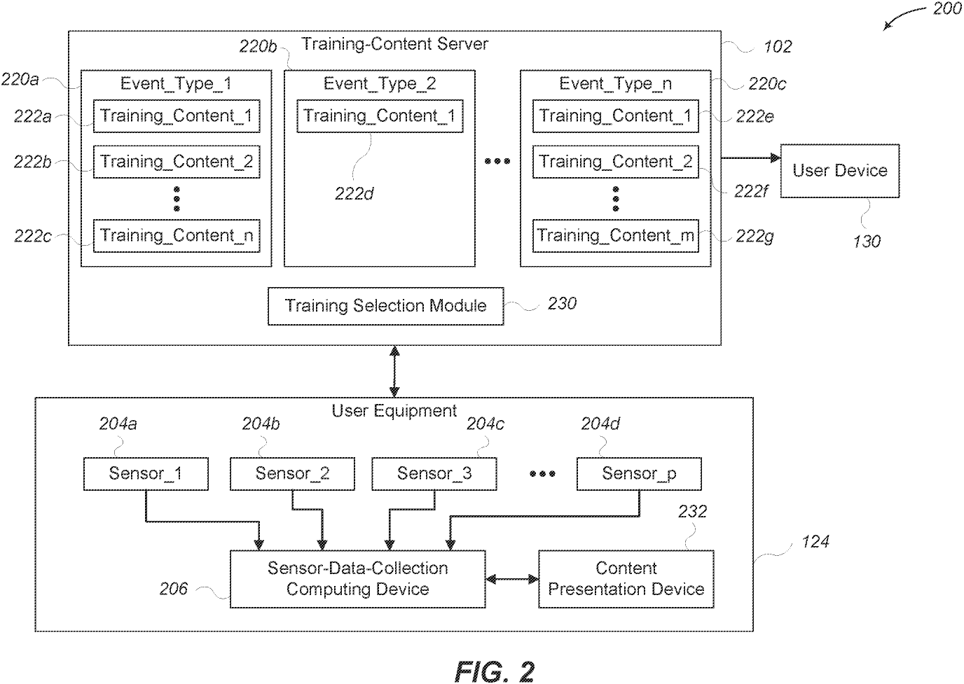

FIG. 2 is a context diagram of non-limiting embodiments of systems for tracking and utilizing user-equipment data to provide training content to a user in accordance with embodiments described herein.

Example 200 includes a training-content server 102, a user equipment 124, and a user device 130, which are generally discussed above in conjunction with FIG. 1.

The user equipment 124 includes one or more sensors 204a-204d, a sensor-data-collection computing device 206, and a content presentation device 232. In some embodiments, the content presentation device 232 may be optional and may not be included in the equipment 124.

The sensors 204a-204d may include any type of sensor, component, or indicator that can provide information or sensor data regarding some feature, accessory, or operating parameter of the user equipment 124. Examples of sensor data include, but are not limited to, engine RPMs (revolutions per minute), engine temperature, gas or break or clutch pedal position, current gear, changes from one gear to another, various fluid pressures or temperatures, video (e.g., video captured from a camera positioned towards the user/operator), audio (e.g., audio of the engine, audio of the equipment, audio in a cab of the equipment, etc.), button or switch positions, changes in button or switch positions, equipment accessory positions or movements (e.g., blade height on a bulldozer, movement of a backhoe, etc.), status or changes of warning lights, status or changes in gauges or user displays, etc. In some embodiments, the sensor data may also be captured prior to (for a select amount of time) or during started up of the equipment. In other embodiments, the sensor data may be captured for a select amount of time after the equipment is stopped, parked, or turned off.

The sensor-data-collection computing device 206 is structured or configured to receive the sensor data from the sensors 204a-204d. The sensor-data-collection computing device 206 communicates with the sensors 204a-204d via one or more wired or wireless communication connections. In some embodiments, one or more of the sensors 204a-204d publish sensor data to the sensor-data-collection computing device 206 without being requested or prompted by the sensor-data-collection computing device 206. In other embodiments, the sensor-data-collection computing device 206 requests the sensor data from one or more of the sensors 204a-204d. As one example, the sensors 204a-204d can provide sensor data to the sensor-data-collection computing device 206 via a CAN bus (not illustrated) on the equipment 124.

After the sensor-data-collection computing device 206 collects, receives, or otherwise obtains the sensor data, the sensor-data-collection computing device 206 provides the sensor data to the training-content server 102. In some embodiments, the sensor-data-collection computing device 206 may receive training content from the training-content server 102 to provide to a user of the user equipment 124. The sensor-data-collection computing device 206 can receive this selected training content and provide it to a user via the content presentation device 232 (e.g., via a display device, audio system, or some combination thereof). In some embodiments, the sensor-data-collection computing device 206 may perform embodiments of the training-content server 102 to store or access training content, analyze the sensor data to detect events, select training content based on the detected event and provide the training content to the user.

The training-content server 102 includes a training selection module 230 and stores a plurality of training content 222a-222g for a plurality of event types 220a-220c.

The plurality of training content 222a-222g are stored, categorized, or otherwise managed by event type 220a-220c. For example, training content 222a-222c are stored and categorized as training content for event 220a, training content 222d is stored and categorized as training content for event 220b, and training content 222e-222g are stored and categorized as training content for event 220c. One or more different pieces of training content 222 may be stored for each event type 220. Although FIG. 2 illustrates the training content 222a-222g as being stored on the training-content server 102, embodiments are not so limited. In some embodiments, the training content 222a-222g may be stored on a database (not illustrated) that is separate from or remote to the training-content server 102.

Each event type 220 may be selected or defined for a particular event type, a particular sub-event type, a plurality of event types, a plurality of sub-event types, or some combination thereof. The event types 220a-220c is one way of grouping the training content 222a-222g, such that training content can be selected based on the event detected in the sensor data. The training content 222a-222g can also be stored or categorized for particular events, a particular piece of equipment, a particular equipment type, a plurality of pieces of equipment, for a plurality of equipment types, or some combination thereof.

The training selection module 230 receives the sensor data from the user equipment 124 and analyzes the sensor data for events, as described herein. In response to an event being detected, the training selection module 230 determines the appropriate event type 220a-220c for that event and selects training content 222 that can train the user of the equipment 124 to improve operation or reduce the likelihood of a repeating event. For example, when the equipment sensor data is analyzed and an event having an event type 220a is detected, the training selection module 230 can select one or more of training content 222a-222c to provide to the user of the equipment.

The training selection module 230 can then provide the selected training content to the user of the equipment 124. In some embodiments, the training selection module 230 can provide the selected training content to the user device 130 for presentation to the user. In other embodiments, the training selection module 230 can provide the selected training content to the user equipment 124 for presentation to the user via the content presentation device 232. In yet other embodiments, the training selection module 230 can present the selected training content to the user itself via an audio or video interface (not illustrated). In some embodiments, the training selection module 230 may also generate equipment modification suggestions based on the detected events or a history of detected events, as described herein.

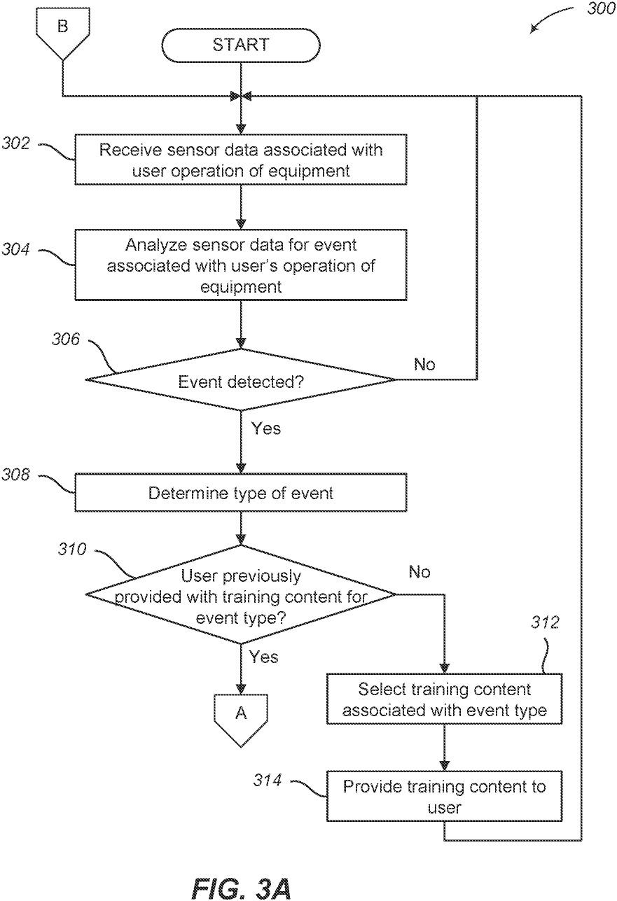

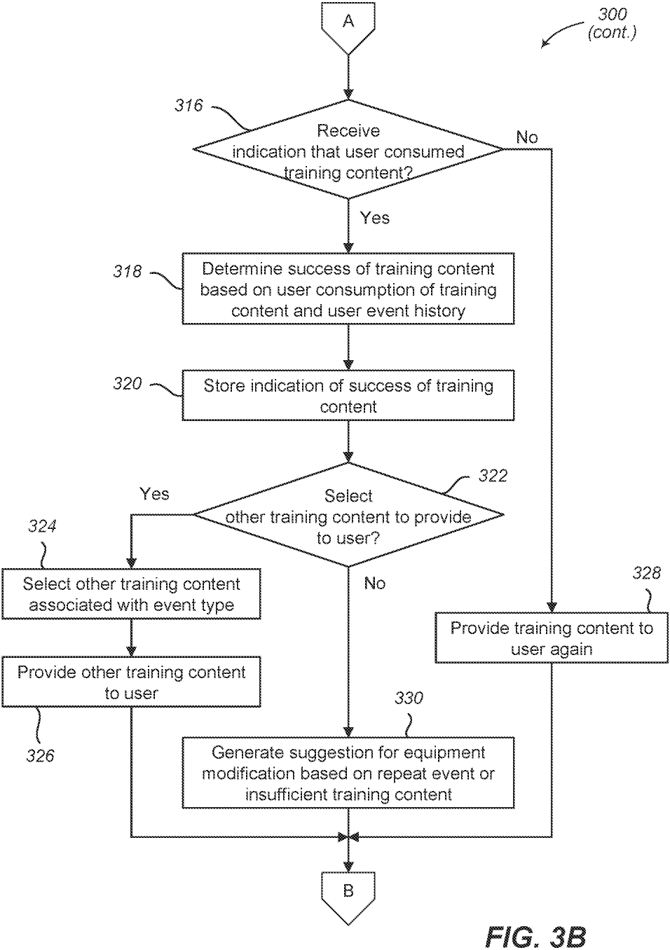

The operation of certain aspects will now be described with respect to FIGS. 3A-3B. In at least one of various embodiments, process 300 described in conjunction with FIGS. 3A-3B may be implemented by or executed via circuitry or on one or more computing devices, such as training-content server 102, user equipment 124, or user device 130 in FIG. 1, so some combination thereof.

FIGS. 3A-3B illustrate a logical flow diagram showing one embodiment of a process 300 for tracking and utilizing user-equipment data to provide training content to a user in accordance with embodiments described herein.

After a start block in FIG. 3A, process 300 begins at block 302, where sensor data is received. This sensor data is data received from a plurality of sensors associated with equipment that is being operated by a user. In various, embodiments, the sensor data is collected during the user’s operation of the equipment. Examples of such sensor data include, but are not limited to, engine RPMs (revolutions per minute), engine temperature, gas or break or clutch pedal position, current gear, changes from one gear to another, various fluid pressures or temperatures, video (e.g., video captured from a camera positioned towards the user/operator), audio (e.g., audio of the engine, audio of the equipment, audio in a cab of the equipment, etc.), button or switch positions, changes in button or switch positions, equipment accessory positions or movements (e.g., blade height on a bulldozer, movement of a backhoe, etc.), status or changes of warning lights, status or changes in gauges or user displays, etc. In some embodiments, the sensor data may also be captured prior to (for a select amount of time) or during started up of the equipment. In other embodiments, the sensor data may be captured for a select amount of time after the equipment is stopped, parked, or turned off.

Process 300 proceeds to block 304, where the sensor data is analyzed for an event. As discussed herein, an event may be a defined sensor reading (e.g., sensor data value exceeding a select threshold), trends in one or more types sensor data over time (e.g., maximum blade height becomes less and less over time), relative sensor values between two or more sensors (e.g., RPMs, gas pedal position, and clutch position during a gear shift), or some combination thereof.

In some embodiments, an administrator, owner of the equipment, or other party may select, set, or define the events. In other embodiments, the events may be selected, set, or defined by utilizing one or more machine learning techniques on training sensor data that includes previously known events.

Process 300 continues to decision block 306, where a determination is made whether an event is detected. If no event is detected in the analysis of the sensor data, then process 300 loops to block 302 to continue to receive sensor data; otherwise, process 300 flows to block 308.

At block 308, a type of event is determined for the detected event. In various embodiments, the event type identifies category in which the event belongs. For example, the event may be an indication that the clutch position was half-way depressed when shifting from first gear to second gear. The event type for this example event may be “shifting from first gear to second gear.” As another example, the event may be an indication that the RPMs were over a select threshold when shifting from first gear to second gear. Again, the event type may be “shifting from first gear to second gear.” In some embodiments, a sub-event type may be determined from the detected event. For example, the previous examples discussed above the event type of “shifting from first gear to second gear.” This event type may be a sub-event type of a master event type “shifting.”

Process 300 proceeds next to decision block 310, where a determination is made whether the user was previously provided with training content for the determined event type. In some embodiments, the system may store or track which events are detected for a particular user, the event types for those detected events for that particular user, and the training content that was provided to that particular user based on those events and event types. If the user was previously provided with training content for the event type, then process flows to decision block 316 on FIG. 3B; otherwise, process 300 flows to block 312.

At block 312, where the user was not previously provided with training content, training content associated with the event type is selected. As discussed herein, one or more training content may be stored based on event type, or sub-event or master event. Using the event type, training content is selected that is most closely associated with the event. Continuing the previous examples, if the event type for the detected event is “shifting from first gear to second gear,” then the selected content may be a video that demonstrates the proper way for a person to shift from first gear to second gear for the equipment being operated by the user.

In some embodiments, the training content that is selected may also be determined based on event itself, along with the event type. For example, if the user only depressed the clutch 75 percent of the way down when shifting from first gear to second gear, then it may be determined that the user is being lazy when shifting those particular gears and thus needs to be informed of the damage that can be caused by not fully engaging the clutch when shifting from first gear to second gear. In comparison, if the user only depressed the clutch 25 percent of the way down when shifting from first gear to second gear, then it may be determined that the user has no idea how to shift gears in general and thus needs a complete training guide on to shift gears for that equipment.

In various embodiments, one or more thresholds, value ranges, settings, or other data parameters may be utilized to select the training content. These thresholds, value ranges, settings, or other data parameters may be apart or independent from the thresholds, value ranges, settings, or other data parameters used to detect the event from the sensor data.

Process 300 continues next at block 314, where the selected training content is provided to the user of the equipment. The training content may be audio content, visual content, or audiovisual content. In some embodiments, the training content includes graphical content, such as images, videos, icons, graphics, or other visual content, which is displayed to the user. In other embodiments, the training content includes audio content, such as audio instructions, sounds, audio alerts, or other audible content, which is output to the user via a speaker.

In various embodiment, the training content is presented to the user via a personal computing device, such as a smartphone, laptop computer, etc. In other embodiments, the training content may be presented to the user via an interface built in or integrated into the equipment, such as by a head unit, infotainment device, or other graphical or audio equipment interface.

After block 314, process 300 loops to block 302 to receive additional sensor data associated with the user’s continued operation of the equipment. In this way, the looping of process 300 can be used to determine if the training content was successful or unsuccessful at teaching the user to avoid the event associated with the training content.

If, at decision block 310, the user was previously provided with training content for the event type determined at block 308, then process 300 flows from decision block 310 to decision block 316 on FIG. 3B.

At decision block 316, a determination is made whether an indication that the user consumed the training content is received. In various embodiments, the user may provide an input that indicates the user viewed or listened to the training content. In other embodiments, the playback of the training content is monitored by the system. For example, when the user accesses, plays, stops, pauses, rewinds, or otherwise interacts with the training content can be monitored to determine if the user consumed all of the training content.

In some embodiments, if the user never starts the training content, then no indication of user consumption is received. In other embodiments, if the user does not start the training content in a selected amount of time after it is provided to the user, then an notice may be received indicating that the user has not consumed the training content. If the user starts, but does not finish the training content or fast forwards through the training content, then a notice may be provided indicating that the user did not fully consume the training content. In some other embodiments, video of the user may be captured while the training content is being provided to the user. In this way, the video can be analyzed or monitored to determine if the user remains present and engaged in the training content as the training content is being presented to the user. This analysis or monitoring may be performed using one or more facial recognition techniques that determine an attention direction of the user. If the user’s attention is not directed at the interface that is presenting the training content, then a notice indicating that the user did not consume the training content may be generated.

If an indication that the user consumed the training content is received, then process 300 flows to block 318; otherwise, process 300 flows to block 328, where the training content is provided to the user again for representation to the user. After block 328, process 300 loops to block 302 on FIG. 3A.

At block 318, the success of the training content is determined. In various embodiments, the success of the training content may be determined based on the user’s consumption of the training content and the user’s event history. For example, if the user’s history indicates multiple detections the same event, and the user fully consumed the training content in the past, then the training content may be unsuccessful at training that user to avoid that type of event.

Process 300 proceeds to block 320, where an indication of success of the training content is stored.

Process 300 continues at decision block 322, where a determination is made whether other training content is to be provided to the user. In some embodiments, this determination is made based on the determined success of the previously provided training content. For example, if the previous training content did not successfully train the user to avoid the event, then other training content may be helpful in training the user.

As an illustrative example, assume the detected event (at blocks 304 and 306 in FIG. 3A) is that the user only depressed the clutch 25 percent of the way down when shifting from first gear to second gear and the previous training content that was selected and provided to the user (at blocks 312 and 314 in FIG. 3A) was a video with a complete training guide on to shift gears for that equipment. Upon process 300 looping to obtain and analyze additional sensor data, assume the user now depressed the clutch 75 percent of the way down when shifting from first gear to second gear. In this example, it may be determined at decision block 308 that other training content is to be provided to the user. Conversely, if the user continues to depress the clutch only 25 percent, then it may be determined that other training content may not help the user; rather, it may be a failure or defect in the equipment.

If other training content is to be provided to the user, process 300 flows from decision block 322 to block 324; otherwise, process 300 flows to block 330.

At block 324, other training content associated with the event type is selected. In various embodiments, block 324 may employ embodiments of block 312 in FIG. 3A to select training content, while taking into account the previous training content provided to the user and any changes in the sensor data or the event detected. In some embodiments, the other training content may be selected based on a type of content. For example, if the previous training content was audio content, but was unsuccessful at training the user to avoid the event type, then the selected other training content may be video content with diagrams showing how to correct or avoid the event.

Process 300 proceeds to block 326, where the other training content is provided to the user. In various embodiments, block 326 may employ embodiments of block 314 in FIG. 3A to provide the select other training content to the user. After block 324, process 300 loops to block 302 on FIG. 3A.

If, at decision block 322, it is determined that other training content is not to be selected and provided to the user, process 300 flows from decision block 322 to block 330.

At block 330, a suggestion is generated for one or more equipment modifications based on the event or insufficient training content. In some embodiments, the suggestion may identify an error, defect, or failure in the equipment based on repeated events. For example, if the user continues to only depress the clutch 25 percent when changing from first gear to second gear and the training content continues to be unsuccessful, then the suggestion may identify a failure in the clutch mechanism. As another example, the suggestion may indicate that the seat is positioned too far back.

After block 330, process 300 loops to block 302 on FIG. 3A.

Although process 300 is primarily directed to detecting events and providing training content to a single user, embodiments are not so limited. In some embodiments, the detected events, types of events, and training content provided to a plurality of users may be aggregated. In some embodiments, this aggregation may be for a plurality of users operating the same equipment. In other embodiments, this aggregation may be for a plurality of users operating different equipment of a same equipment type. In this way, the training content can be tailored for a plurality of users, for different types of equipment, etc. Moreover, equipment modifications can be identified and suggested at block 330 based on multiple similar events being detected for multiple users operating different equipment of a same or similar equipment type.

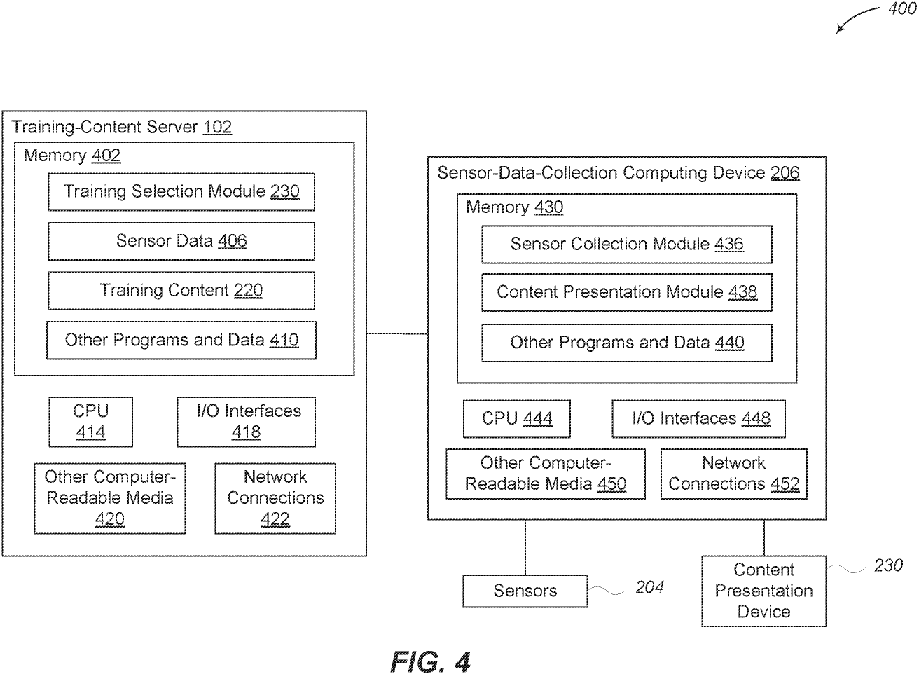

FIG. 4 shows a system diagram that describe various implementations of computing systems for implementing embodiments described herein. System 400 includes a training-content server 102 and a sensor-data-collection computing device 206.

The training-content server 102 receives sensor data from the sensor-data-collection computing device 206 of one or more user equipment 124. The training-content server 102 analyzes the sensor data to determine if an event has occurred and provides training content to equipment operators in response to detection of an event in the sensor data. One or more special-purpose computing systems may be used to implement the training-content server 102. Accordingly, various embodiments described herein may be implemented in software, hardware, firmware, or in some combination thereof. training-content server 102 may include memory 402, one or more central processing units (CPUs) 414, I/O interfaces 418, other computer-readable media 420, and network connections 422.

Memory 402 may include one or more various types of non-volatile and/or volatile storage technologies. Examples of memory 402 may include, but are not limited to, flash memory, hard disk drives, optical drives, solid-state drives, various types of random access memory (RAM), various types of read-only memory (ROM), other computer-readable storage media (also referred to as processor-readable storage media), or the like, or any combination thereof. Memory 402 may be utilized to store information, including computer-readable instructions that are utilized by CPU 414 to perform actions, including embodiments described herein.

Memory 402 may have stored thereon training selection module 230, sensor data 406, and training content 220. The training selection module 230 is configured to perform embodiments described herein to analyze the sensor data for events. If an event is identified in the sensor data, then the training selection module 230 selects and provides training content to a user that was operating the equipment 124 when the sensor data was obtained or collected. In some embodiments, the training selection module 230 provides the selected training content to the sensor-data-collection computing device 206 to be presented to the user. In other embodiments, the training selection module 230 provides the selected training content to another computing device, such as user device 130 in FIG. 1, for presentation to the user. In various embodiments, the training selection module 230, or another module (not illustrated), may generate equipment modification suggestions or recommendations based on the sensor data and history of the success of training content.

The sensor data 406 may include sensor data for particular equipment for a particular user, sensor data for multiple pieces of equipment for a particular user, sensor data for multiple pieces of equipment for multiple users, sensor data for particular equipment for multiple users, or sensor data for one or more types of equipment for one or more users, or some combination thereof. The training content 220 may include a plurality of pieces of training content in one or more forms (e.g., video, audio, or audiovisual) for one or more event types, one or more events, one or more types of equipment, etc., as discussed herein. Memory 402 may also store other programs and data 410, which may operating systems, equipment data, event histories for one or more users, etc.

In various embodiments, the network connections 422 include transmitters and receivers (not illustrated) to send and receive data as described herein. I/O interfaces 418 may include a video or audio interfaces, other data input or output interfaces, or the like, which can be used to receive or output information to an administrator, among other actions. Other computer-readable media 420 may include other types of stationary or removable computer-readable media, such as removable flash drives, external hard drives, or the like.

Sensor-data-collection computing device 206 collects sensor data from one or more sensors 204 and provides that sensor data to the training-content server 102, as described herein. In some embodiments, the sensor-data-collection computing device 206 may receive training content from the training-content server 102 and present it to a user, such as via content presentation device 230. One or more special-purpose computing systems may be used to implement sensor-data-collection computing device 206. Accordingly, various embodiments described herein may be implemented in software, hardware, firmware, or in some combination thereof. Sensor-data-collection computing device 206 may include memory 430, one or more central processing units (CPUs) 444, I/O interfaces 448, other computer-readable media 450, and network connections 452.

Memory 430 may include one or more various types of non-volatile and/or volatile storage technologies similar to memory 402. Memory 430 may be utilized to store information, including computer-readable instructions that are utilized by CPU 444 to perform actions, including embodiments described herein.

Memory 430 may have stored thereon sensor collection module 436 and content presentation module 438. The sensor collection module 436 may communicate with sensors 204 to collect, obtain, or otherwise receive sensor data. Once the sensor data is obtained, the sensor collection module 436 provides the sensor data to the training-content server 102. The content presentation module 438 may communicate with the training-content server 102 to obtain training content to provide to the user via the content presentation device 230. In some embodiments, the sensor collection module 436 and the content presentation module 436 and operate together to perform embodiments of the training selection module 230 of the training-content server 102 to analyze the sensor data and to select training content. Although the sensor collection module 436 and the content presentation module 438 are illustrated separately, embodiments are not so limited. In some embodiments, the functionality of the sensor collection module 436 and the content presentation module 438 may be performed by a single module or by more modules than what is illustrated. Memory 430 may also store other programs and data 440, which may include sensor data, training content, equipment data, or other information.

Network connections 452 are configured to communicate with other computing devices, such as training-content server 102, sensors 204, content presentation device 230, or other computing devices (not illustrated). In various embodiments, the network connections 452 include transmitters and receivers (not illustrated) to send and receive data as described herein. I/O interfaces 448 may include one or more other data input or output interfaces. Other computer-readable media 450 may include other types of stationary or removable computer-readable media, such as removable flash drives, external hard drives, or the like.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A computing device, comprising:
a memory configured to store computer instructions; and
a processor configured to execute the computer instructions to:
receive sensor data associated with a user’s operation of equipment;
detect an event based on an analysis of the sensor data;
identify an event type for the event;
select training content to teach the user to avoid the event based on the event type;
present the selected training content to the user;
receive an indication that the user consumed the selected training content;
receive additional sensor data associated with the user’s continued operation of the equipment after the user consumed the selected training content; and
in response to detecting a reoccurrence of the event based on an analysis of the additional sensor data, determine that the selected training content was unsuccessful at training the user to avoid the event.

2. The computing device of claim 1, wherein the processor determines that the selected training content was unsuccessful at training the user to avoid the event by being configured to further execute the computer instructions to:
obtain a history of events matching the event type for the user;
analyze the additional sensor data relative to the obtained history of events for the user; and
in response to detecting the event based on the analysis of the additional sensor data and the obtained history, label the selected training content as insufficient at training the user to avoid the event.

3. The computing device of claim 1, wherein the processor is configured to further execute the computer instructions to:
generate a suggestion for modifying the equipment based on the unsuccessful training content and the event type.

4. The computing device of claim 1, wherein the processor is configured to further execute the computer instructions to:
selecting additional training content to teach the user to avoid the event based on the event type; and
presenting the additional selected training content to the user.

5. The computing device of claim 4, wherein the processor is configured to further execute the computer instructions to:
receive further sensor data associated with the user’s continued operation of the equipment after the user consumed the additional selected training content; and
in response to detecting another reoccurrence of the event based on an analysis of the further sensor data, label the user as unable to operate the equipment.

6. The computing device of claim 1, wherein the processor is configured to further execute the computer instructions to:
receive further sensor data associated with a plurality of users operating a plurality of equipment that shares an equipment type with the equipment;
determining that the selected training content was unsuccessful at training the plurality of users; and
generating a suggestion for modifying the equipment type based on the unsuccessful training content and the event type.

7. The computing device of claim 1, further comprising:
receive an indication that the user failed to consume the selected training content; and
re-present the selected training content to the user at a later time.

8. A method, comprising:
receiving sensor data associated with a user’s operation of equipment;
detecting an event based on an analysis of the sensor data;
identifying an event type for the event;
selecting training content to teach the user to avoid the event based on the event type; and
presenting the selected training content to the user.

9. The method of claim 8, further comprising:
receiving an indication that the user consumed the selected training content;
receiving additional sensor data associated with the user’s continued operation of the equipment; and
in response to detecting the event based on an analysis of the additional sensor data, determining that the selected training content was unsuccessful at training the user to avoid the event.

10. The method of claim 8, further comprising:
obtaining a history of events matching the event type for the user;
receiving additional sensor data associated with the user’s continued operation of the equipment; and
in response to detecting the event based on an analysis of the additional sensor data and the obtained history, labeling the selected training content as insufficient at training the user to avoid the event.

11. The method of claim 8, further comprising:
determining that the selected training content was unsuccessful at training a plurality of users operating the equipment; and
generating a suggestion for modifying the equipment based on the unsuccessful training content and the event type.

12. The method of claim 8, further comprising:
receiving additional sensor data associated with a plurality of users operating a plurality of equipment that shares an equipment type with the equipment;
determining that the selected training content was unsuccessful at training the plurality of users in response to detection of the event in the additional sensor data for the plurality of users; and
generating a suggestion for modifying the equipment based on the unsuccessful training content and the event type.

13. The method of claim 8, further comprising:
determining that the selected training content was unsuccessful at training the user based on a reoccurrence of the event while the user is operating the equipment;
selecting additional training content to teach the user to avoid the event based on the event type; and
presenting the additional selected training content to the user.

14. The method of claim 13, further comprising:
receiving further sensor data associated with the user’s continued operation of the equipment after the user consumed the additional selected training content; and
in response to detecting another reoccurrence of the event based on an analysis of the further sensor data, labeling the user as unable to operate the equipment.

15. The method of claim 8, further comprising:
receiving an indication that the user failed to consume the selected training content; and
re-present the selected training content to the user at a later time.

16. A non-transitory computer-readable medium storing computer instructions that, when executed by at least one processor, cause the at least one processor to perform actions, the actions comprising:
receiving sensor data associated with a user’s operation of equipment;
detecting an event based on an analysis of the sensor data;
identifying an event type for the event;
selecting training content to teach the user to avoid the event based on the event type;
presenting the selected training content to the user;
receiving an indication of whether the user consumed the selected training content;
receiving additional sensor data associated with the user’s continued operation of the equipment;
in response to detecting the event based on an analysis of the additional sensor data and the user consuming the selected training content, determining that the selected training content was unsuccessful at training the user to avoid the event; and
in response to detecting the event based on an analysis of the additional sensor data and the user failed to consume the selected training content, re-presenting the selected training content the user.

17. The non-transitory computer-readable medium of claim 16, wherein the computer instructions that, when executed by at least one processor, cause the at least one processor to perform further actions, the further actions comprising:
obtaining a history of events matching the event type for the user; and
labeling the selected training content as insufficient at training the user to avoid the event based on a pattern of reoccurrences of the event type in the history of events.

18. The non-transitory computer-readable medium of claim 16, wherein the computer instructions that, when executed by at least one processor, cause the at least one processor to perform further actions, the further actions comprising:
receiving further sensor data associated with a plurality of users’ operating the equipment;
providing the selected training content to the plurality of users in response to the event being detected in the further sensor data;
determining that the selected training content was unsuccessful at training the plurality of users; and
generating a suggestion for modifying the equipment based on the unsuccessful training content and the event type.

19. The non-transitory computer-readable medium of claim 16, wherein the computer instructions that, when executed by at least one processor, cause the at least one processor to perform further actions, the further actions comprising:
determining that the selected training content was unsuccessful at training the user based on a reoccurrence of the event while the user is operating the equipment;
selecting additional training content to teach the user to avoid the event based on the event type; and
presenting the additional selected training content to the user.

20. The non-transitory computer-readable medium of claim 16, wherein the computer instructions that, when executed by at least one processor, cause the at least one processor to perform further actions, the further actions comprising:
receiving further sensor data associated with the user’s continued operation of the equipment after the user consumed the additional selected training content; and
in response to detecting another reoccurrence of the event based on an analysis of the further sensor data, labeling the user as unable to operate the equipment.

21. The non-transitory computer-readable medium of claim 16, wherein the computer instructions that, when executed by at least one processor, cause the at least one processor to perform further actions, the further actions comprising:
receiving an indication that the user failed to consume the selected training content; and
re-present the selected training content to the user at a later time.
